(19) United States
(12) Patent Application Publication
(10) Pub. No.: US 2023/0374259 A1
(43) Pub. Date: Nov. 23, 2023

(54) Bioplastic Material

(71) Applicants: RAHUL SISTA, Plano, TX (US); SRICHARAN KANNAN, San Ramon, CA (US); NAVEEN ARUNACHALAM SAKTHIYENDRAN, Bellevue, WA (US)

(72) Inventors: RAHUL SISTA, Plano, TX (US); SRICHARAN KANNAN, San Ramon, CA (US); NAVEEN ARUNACHALAM SAKTHIYENDRAN, Bellevue, WA (US)

(21) Appl. No.: 18/044,053

(22) PCT Filed: Mar. 15, 2021
(86) PCT No.: PCT/IN2021/050263

§ 371 Date: Mar. 3, 2023

(30) Foreign Application Priority Data
Sep. 3, 2020 (IN) 202041038102

(51) Int. Cl. C08K 5/00; C05G 5/40; C08K 3/34; C08J 3/22

(52) U.S. Cl. CPC C08K 5/0016; C05G 5/40; C08K 3/346; C08J 3/22; C08K 2201/018; C08K 2201/011; C08J 2300/16

(57) ABSTRACT

A method (((100))) of obtaining a bioplastic material is disclosed. The method (((100))) includes adding a carbon polymer and a solvent into a batch container then mixing the carbon polymer and the solvent thoroughly to obtain a base mixture, adding a plasticizer complex and an enzyme to the base mixture and mixing thoroughly to obtain a first mixture, adding a fertilizer material to the first mixture and mixing thoroughly to obtain a second mixture, supplying a heat with a predefined temperature to the second mixture, wherein once the second mixture converts to a gel-like semi-solid, then transfer the gel-like semi-solid mixture to a cooling system, incubating the gel-like semi-solid mixture to the cooling system for a predefined period of time. The method further includes molding the incubated gel-like semi-solid mixture into required shapes and forms.

### PRIORITY PARAGRAPH

1. This application claims priority to the PCT application PCT/IN2021/050263 titled “Bioplastic material” filed on 15 Mar. 2021 that claims priority to the provisional application 202041038102 titled “Bioplastic Material” filed on 3 Sep. 2020 in the Indian Patent Office, both of which are incorporated herein fully by reference.

### BACKGROUND

### Technical Field

2. The embodiment herein generally relates to biodegradable plastics, and more particularly, to a bioplastic material.

### Description of the Related Art

3. For a long time, an issue with plastics are single utilization. Plastic wastes are usually dumped onto lands and the plastic waste does not biodegrade into the land and often the lands are contaminated where the plastic wastes are dumped. Existing bridgeable plastics are not that efficient. Accordingly, there remains a need for a bioplastic material.

### SUMMARY

4. In view of the foregoing, embodiments herein provide a bioplastic material for providing various modes of packaging of one or more items. The material includes a carbon polymers, a plasticizer complex, a solvent, a nanoclay, a catalyst that breaks down carbons of the carbon polymers, and a fertilizer material. The carbon polymers, the plasticizer complex, solvent, catalyst, and the fertilizer material are mixed together at different stages obtain the bioplastic material.

5. In some embodiments, the material when placed into soil is reusable as fertilizer.

6. In some embodiments, the plasticizer complex is used in combination with protein or carbon polymer complexes.

7. In some embodiments, the carbon polymer is a structure basis of the bioplastic material.

8. In one aspect, method of obtaining a bioplastic material is provided. The method includes adding a carbon polymer and a solvent into a batch container then mixing the carbon polymer and the solvent thoroughly to obtain a base mixture. The method further includes adding a plasticizer complex and an enzyme to the base mixture and mixing thoroughly to obtain a first mixture. The method further includes adding a fertilizer material to the first mixture and mixing thoroughly to obtain a second mixture. The method further includes adding a nanoclay compound to the second mixture and mixing until the nanoclay completely incorporates into the carbon polymer. The method further includes supplying a heat with a predefined temperature to the second mixture, wherein once the second mixture converts to a gel-like semi-solid, then transfer the gel-like semi-solid to a cooling system. The method further includes incubating the gel-like semi-solid to the cooling system for a predefined period of time. The method further includes molding the incubated gel-like semi-solid mixture into required shapes and forms.

9. In some embodiments, the solvent provides a bonding between the plasticizer complex and the fertilizer material.

10. In some embodiments, the carbon polymer is a structural basis of the bioplastic material.

11. In some embodiments, the catalyst breaks down a carbon compounds of the carbon polymer in order to restructure as the carbon polymer bonds with the plasticizer complex.

12. In some embodiments, the plasticizer complex and the carbon polymer provides structural integrity and malleability characteristics for the bioplastic material.

13. In some embodiments, the bioplastic material when placed into soil is reusable as fertilizer.

14. These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

15. The embodiments herein will be better understood from the following detailed description with reference to the drawings, in which:

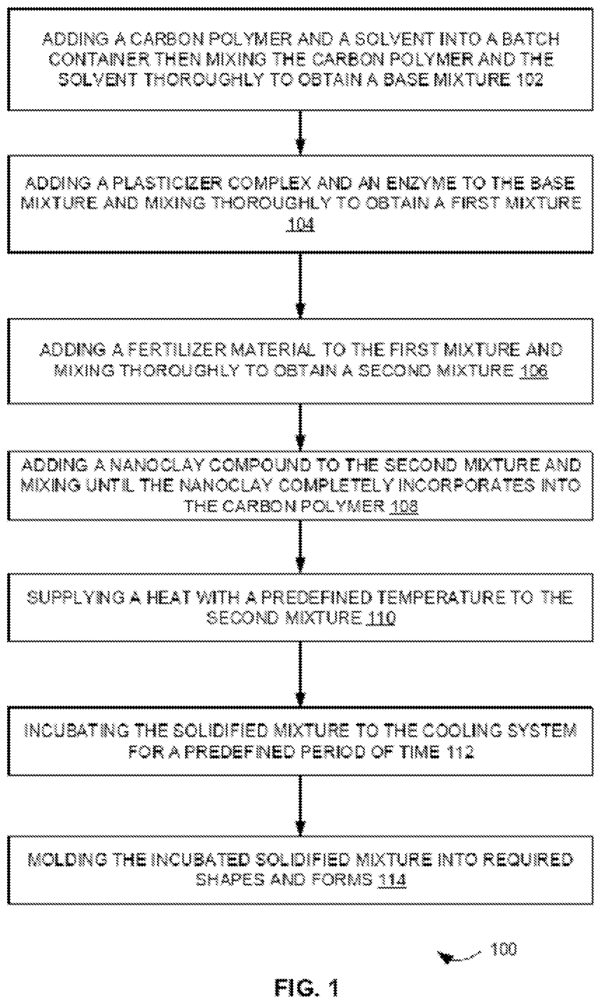

16. FIG. 1 illustrates a method of obtaining a bioplastic material, according to some embodiments herein.

### DETAILED DESCRIPTION OF PREFERRED EMBODIMENTS

17. The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

18. As mentioned, there remains a need for a bioplastic material. The embodiments herein achieve this by providing a method for obtaining the bioplastic material. Referring now to the drawings, and more particularly to FIG. 1, where similar reference characters denote corresponding features consistently throughout the figures, there are shown preferred embodiments.

19. FIG. 1 illustrates a method (100) of obtaining a bioplastic material, according to some embodiments herein. At step 102, the method (100) includes adding a carbon polymer and a solvent into a batch container then mixing the carbon polymer and the solvent thoroughly to obtain a base mixture. At step 104, the method (100) includes adding a plasticizer complex and an enzyme to the base mixture and mixing thoroughly to obtain a first mixture. At step 106, the method (100) includes adding a fertilizer material to the first mixture and mixing thoroughly to obtain a second mixture. At step 108, the method (100) includes the method further includes adding a nanoclay compound to the second mixture and mixing until the nanoclay completely incorporates into the carbon polymer. At step 110, the method (100) includes supplying a heat with a predefined temperature to the second mixture. Once the second mixture converts to a gel-like semi-solid, then transfer the gel-like semi-solid to a cooling system. At step 112, the method (100) includes incubating the solidified mixture to the cooling system for a predefined period of time. At step 114, the method (100) includes molding the incubated solidified mixture into required shapes and forms.

20. In some embodiments, the bioplastic material includes a carbon polymers, a plasticizer complex, a solvent, a nanoclay, a catalyst that breaks down carbons of the carbon polymers, and a fertilizer material. The carbon polymers, the plasticizer complex, solvent, catalyst, and the fertilizer material are mixed together at different stages to obtain the bioplastic material. 21. In some embodiments, the solvent provides a bonding between the plasticizer complex and the fertilizer material. The bonding means providing adhesive properties between the plasticizer complex and the fertilizer material. The carbon polymer is a structural basis of the bioplastic material. The catalyst breaks down a carbon compounds of the carbon polymer in order to restructure as the carbon polymer bonds with the plasticizer complex. The plasticizer complex and the carbon polymer provides structural integrity and malleability characteristics for the bioplastic material. The bioplastic material when placed into soil is reusable as fertilizer. The bioplastic material allows for the bioplastic to degrade completely into the soil as the fertilizer. The fertilizer enriches a quality of the soil in order to improve the quality and a quantity of crops grown which in turn is beneficial to a farmer, helping the farmer and environment.

22. In an embodiment, the nanoclay also known as nanoadditive or nanoparticle, essentially consists of layered silicates stacked together. The nanoclay is a cost-effective additive to augment mechanical, thermal, and barrier properties of the bioplastic material. The nanoclay may include montmorillonite nanoclays, an alloysite nanoclay, a hydrophilic bentonite, the nanoclay containing Amine and Ammonium particulates, Cellulose NanoWhiskers (CNW), keratin (complements especially when reinforced with microcrystalline cellulose), a ramie Fiber, and other nanoclay varieties that are available and support organic and natural polymers. The nanoclay provides a tensile strength promoting agent, and the nanoclay functions as a structural assistant.

23. In some embodiments, the carbon polymer may include a corn starch, a cellulose (hydroxypropyl methylcellulose (HPMC) variety, and as microcrystalline), a potato starch, a wheat flour, a coconut flour and the like. The plasticizer complex may include a vegetable glycerin, a regular glycerin, a fructose, a resin (epoxy variety or casting resin), a lignin (the lignin is most compatible with the cellulose as carbon source) and the like. The carbon polymers may include a distilled vinegar. The solvent may include water. The fertilizer material may include a coir pith (such as condensed coconut fibers) or a Banana Pith (such as condensed banana skin).

24. In some embodiments, the modes of packaging may include a container, a carry bag, a cover, a wrap, a bottle, and the like. The one or more items may include a food, a liquid, any material which needs to be carried from one place to other with a help of the packaging modes and the like.

25. In a non-limiting embodiment, the bioplastic material includes predefined quantity of materials. The predefined quantity of materials may include measuring 50-130 ml of water in a beaker and then using a measuring scale, measure out 8-30 grams of the carbon polymer and add the carbon polymer to the beaker and thoroughly mix the carbon polymer with the water. Now measuring out 5 ml to 25 ml of plasticizer complex using a measuring scale and add the plasticizer complex to the beaker now add 5 ml-15 ml of the carbon polymers to the mixture, and mix thoroughly. Heat a heating device to a medium to high heat and place the beaker on top of the heating device, using either a magnetic stir bar, or manually using a spatula, start stirring the solution which is inside the beaker evenly. After 8-16 minutes of stirring, the solution will start to solidify, and the liquid solution will start to transform into a gel-like product, now transfer the semi-solid like substance onto a surface, and distribute the product evenly (thickness can be controlled in this step as well). Place the gel-like product in a desired mold to be rested Let the gel rest for 20 hours—4 weeks depending on the portion of product left to cool and dry. The gel-like substance is bioplastic material

26. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

We claim:

1. A bioplastic material for providing various modes of packaging of one or more items, the material comprising:
a carbon polymer((s));
a plasticizer complex;
a solvent;
a nanoclay;
a catalyst that breaks down carbons of the carbon polymers; and
a fertilizer material, wherein the carbon polymers, the plasticizer complex, the solvent, the catalyst, and the fertilizer material are mixed together at different stages to obtain the bioplastic material.

2. The material as claimed in claim 1, wherein the material when placed into soil is reusable as fertilizer.

3. The material as claimed in claim 1, wherein the plasticizer complex is used in combination with protein or carbon polymer complexes.

4. The material as claimed in claim 1, wherein the carbon polymer is a structural basis of the bioplastic material.

5. A method of obtaining a bioplastic material, the method comprising:
adding a carbon polymer and a solvent into a batch container then mixing the carbon polymer and the solvent thoroughly to obtain a base mixture;
adding a plasticizer complex and an enzyme to the base mixture and mixing thoroughly to obtain a first mixture;
adding a fertilizer material to the first mixture and mixing thoroughly to obtain a second mixture;
adding a nanoclay compound to the second mixture and mixing until the nanoclay completely incorporates into the carbon polymer;
supplying a heat with a predefined temperature to the second mixture, wherein once the second mixture converts to a gel-like semi-solid, then transfer the gel-like semi-solid mixture to a cooling system;
incubating the gel-like semi-solid mixture to the cooling system for a predefined period of time; and
molding the incubated gel-like semi-solid mixture into required shapes and forms.

6. The method as claimed in claim 5, wherein the solvent provides a bonding between the plasticizer complex and the fertilizer material.

7. The method as claimed in claim 5, wherein the carbon polymer is a structural basis of the bioplastic material.

8. The method as claimed in claim 5, wherein the catalyst breaks down a carbon compounds of the carbon polymer in order to restructure as the carbon polymer bonds with the plasticizer complex.

9. The method as claimed in claim 5, wherein the plasticizer complex and the carbon polymer provides structural integrity and malleability characteristics for the bioplastic material.

10. The method as claimed in claim 5, wherein the bioplastic material when placed into soil is reusable as fertilizer.
